(19) United States
(12) Patent Application Publication
(10) Pub. No.: US 2026/0296773 A1
(43) Pub. Date: Oct. 1, 2026

(54) Sealable Used Incontinence Garment Bag Device

(71) Applicant: Rhonda Jackson, Brooklyn, NJ (US)

(72) Inventor: Rhonda Jackson, Brooklyn, NJ (US)

(21) Appl. No.: 19/460,789

(22) Filed: Jan. 27, 2026

Related U.S. Application Data
(60) Provisional application No. 63/780,605, filed on Mar. 31, 2025.

(51) Int. Cl. B65F 1/00

(52) U.S. Cl. CPC B65F 1/002; B65F 1/0026; B65F 2210/129; B65F 2210/167; B65F 2240/132

(57) ABSTRACT

A sealable used incontinence garment bag device is provided. The device is comprised of a disposable bag assembly configured for discreet containment and disposal of used incontinence products. The device comprises a bag assembly having a flexible, waterproof bag body. The perimeter edges of the bag body are sealed using methods such as heat sealing, ultrasonic welding, or adhesive bonding to ensure a leak-resistant structure. The body is further impregnated with a fragrance compound and an odor-neutralizing compound such as activated carbon, zeolites, or cyclodextrins, which may be embedded or coated on the interior surfaces. At least one opening of the bag body, located either along a top edge or in a central area is sealable by closure mechanisms including adhesive strips or slidable fastener systems. In certain embodiments, the adhesive strips are used in conjunction with folding the body to seal the bag after used garment insertion.

### CROSS-REFERENCE TO RELATED APPLICATION

The present application claims priority to, and the benefit of, U.S. Provisional Application No. 63/780,605, which was filed on Mar. 31, 2025, and is incorporated herein by reference in its entirety.

### FIELD OF THE INVENTION

The present invention relates generally to the field of disposal bags. More specifically, the present invention relates to a disposable bag assembly configured for the sanitary and discreet containment and disposal of used incontinence products. Accordingly, the present disclosure makes specific reference thereto. Nonetheless, it is to be appreciated that aspects of the present invention are also equally applicable to other like applications, devices, and methods of manufacture.

### BACKGROUND

Adults experiencing incontinence face several challenges in managing their personal hygiene discreetly, particularly in public or shared environments. More specifically, the use of adult diapers, while necessary for health and comfort, can lead to situations where the presence of the diaper is visible to others during disposal, potentially causing embarrassment or discomfort. Conventional disposal methods for used incontinence products often lack privacy, odor control, and sanitation, especially in non-residential settings such as public restrooms, workplaces, or during travel. Improper disposal can also contribute to odor release and an increased risk of cross-contamination, impacting both the user and others in close proximity. Thus, the psychological and social burden associated with managing incontinence discreetly can lead to decreased confidence and reluctance to participate in social activities. Furthermore, the absence of a reliable method for sealing and isolating used garments limits user autonomy and privacy. These problems collectively indicate a need for a portable, hygienic, and discreet disposal system specifically tailored for adult incontinence products.

Therefore, there exists a long-felt need in the art for a sealable used incontinence garment bag device that enables discreet disposal of adult diapers without visual exposure. There also exists a long-felt need in the art for a sealable used incontinence garment bag device that prevents odor escape through integrated neutralizing and sealing mechanisms. Moreover, there exists a long-felt need in the art for a sealable used incontinence garment bag device that allows for hygienic and convenient use in public, residential, and travel environments.

The subject matter disclosed and claimed herein, in one embodiment thereof, comprises a sealable used incontinence garment bag device. The device is comprised of a disposable bag assembly configured for the sanitary and discreet containment and disposal of used incontinence products. The device comprises a bag assembly having a flexible, waterproof bag body. The perimeter edges of the bag body are sealed using methods such as heat sealing, ultrasonic welding, or adhesive bonding to ensure a leak-resistant structure. The body is further impregnated with a fragrance compound and an odor-neutralizing compound such as activated carbon, zeolites, or cyclodextrins, which may be embedded or coated on the interior surfaces. At least one opening of the bag body, located either along a top edge or in a central area is sealable by closure mechanisms including adhesive strips or slidable fastener systems. In certain embodiments, the adhesive strips are used in conjunction with folding the body to seal the bag after used garment insertion.

In this manner, the sealable used incontinence garment bag device of the present invention accomplishes all the foregoing objectives and provides a containment system that ensures user privacy through concealment of used incontinence products. The secure closure mechanisms, combined with odor-masking and neutralizing agents integrated into the bag material, address the challenge of odor emission during transport or disposal. The device can further be used in a variety of settings, including public facilities and travel situations, without compromising hygiene or discretion. The device further eliminates the risk of leakage and contamination through a sealed and waterproof construction. By integrating both functional and hygienic components into a single-use disposable format, the device addresses longstanding challenges related to public embarrassment, odor control, and sanitary disposal, thereby significantly improving the quality of life for individuals managing incontinence.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a sealable used incontinence garment bag device. The device is comprised of a disposable bag assembly configured for hygienic and discreet disposal of used incontinence products while isolating odors, concealing contents, and enabling sanitary disposal in residential, public, or travel settings.

The device is comprised of a bag assembly that may feature sealed edges created using heat sealing, ultrasonic welding, adhesive bonding, or mechanical crimping to form a leak-resistant structure. The bag body is further comprised of a fragrance compound integrated into the material. The bag body is also comprised of an odor-neutralizing compound configured to trap odor molecules. The bag assembly is available as a single-use unit or in a continuous roll, where multiple bag assemblies are connected end-to-end and separated by perforation lines for individual use.

The bag body is comprised of at least one opening configured to receive used incontinence garments. In one embodiment, the opening is positioned along a top edge and may be maintained open by structural features such as a reinforced rim, flexible band, or gusseted top. The opening is sealed using one or more closure mechanisms. In one embodiment, the closure mechanism is an adhesive strip on the interior and/or exterior surface. In another embodiment, the closure mechanism is a slidable fastener system.

In a second embodiment, the opening is centrally positioned on the body. In this embodiment, closure of the opening is achieved using adhesive strips along the perimeter edges or exterior surfaces of the body. After inserting a garment, the bag body is folded along a central axis to engage the adhesive elements and seal the opening by securing the body in a folded configuration.

A method of use includes providing the bag assembly with at least one opening and a closure mechanism, inserting a used incontinence garment into the opening, and sealing the opening using the closure mechanism. In configurations with centrally positioned openings and adhesive strips, the bag body is folded to ensure proper sealing.

Accordingly, the sealable used incontinence garment bag device of the present invention is particularly advantageous as it provides a containment system that ensures user privacy through concealment of used incontinence products. The secure closure mechanisms, combined with odor-masking and neutralizing agents integrated into the bag material, address the challenge of odor emission during transport or disposal. The device can further be used in a variety of settings, including public facilities and travel situations, without compromising hygiene or discretion. The device further eliminates the risk of leakage and contamination through a sealed and waterproof construction. By integrating both functional and hygienic components into a single-use disposable format, the device overcomes the longstanding challenges related to public embarrassment, odor control, and sanitary disposal, thereby significantly improving the quality of life for individuals managing incontinence.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of a first potential embodiment of a sealable used incontinence garment bag device of the present invention while unsealed in accordance with the disclosed architecture;

FIG. 2 illustrates a top view of a second potential embodiment of a sealable used incontinence garment bag device of the present invention while sealed in accordance with the disclosed architecture;

FIG. 3 illustrates a top view of a second potential embodiment of a sealable used incontinence garment bag device of the present invention while unsealed in accordance with the disclosed architecture;

FIG. 4 illustrates a top view of a second potential embodiment of a sealable used incontinence garment bag device of the present invention while sealed and folded in accordance with the disclosed architecture;

FIG. 5 illustrates a top perspective view of a first potential embodiment of a sealable used incontinence garment bag device of the present invention while unsealed in accordance with the disclosed architecture;

FIG. 6 illustrates a top perspective view of a third potential embodiment of a sealable used incontinence garment bag device of the present invention while unsealed in accordance with the disclosed architecture; and

FIG. 7 illustrates a flowchart of a method of using one potential embodiment of a sealable used incontinence garment bag device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a sealable used incontinence garment bag device that enables discreet disposal of adult diapers without visual exposure. There also exists a long-felt need in the art for a sealable used incontinence garment bag device that prevents odor escape through integrated neutralizing and sealing mechanisms. Moreover, there exists a long-felt need in the art for a sealable used incontinence garment bag device that allows for hygienic and convenient use in public, residential, and travel environments.

The present invention, in one exemplary embodiment, is comprised of a sealable used incontinence garment bag device. The device comprises a disposable bag assembly designed for the hygienic and discreet disposal of used incontinence products that isolates odors, conceals used incontinence products, and facilitates sanitary disposal in residential, public, or travel environments.

The device includes a bag assembly featuring sealed edges formed through heat sealing, ultrasonic welding, adhesive bonding, or mechanical crimping, resulting in a leak-resistant structure. The bag body incorporates a fragrance compound embedded within the material and includes an odor-neutralizing compound formulated to trap odor molecules. The bag assembly is provided either as a single-use unit or in a continuous roll format, with multiple bag assemblies joined end-to-end and separated by perforation lines for individual dispensing.

The bag body includes at least one opening configured to accept used incontinence garments. In one configuration, the opening is located along a top edge and may remain open with structural features such as a reinforced rim, flexible band, or gusseted top. One or more closure mechanisms are provided to seal the opening. In one version, an adhesive strip is applied to the interior and/or exterior surface. In another, the closure mechanism takes the form of a slidable fastener system.

An alternative configuration positions the opening centrally on the bag body. In this embodiment, adhesive strips are located along the perimeter edges or exterior surfaces. After garment insertion, the bag body is folded along a central axis, causing the adhesive elements to engage and seal the opening by securing the bag in a folded configuration.

A method of use involves providing a bag assembly equipped with at least one opening and a closure mechanism, inserting a used incontinence garment through the opening, and sealing the opening with the closure mechanism. When centrally positioned openings and adhesive strips are used, folding the bag body along a central axis ensures effective sealing.

As a result, the device provides a containment system that ensures user privacy through effective concealment of contents. Secure closure mechanisms combined with integrated odor-masking and neutralizing agents further mitigates odor emission during disposal or transport. As such, the device supports use in public and travel environments while maintaining hygiene and discretion. A waterproof and sealed construction also eliminates the risk of leakage or contamination. Through the integration of functional and hygienic features into a single-use disposable format, the device addresses key concerns associated with incontinence, including odor control, sanitary disposal, and social discomfort, thereby improving the quality of life for users.

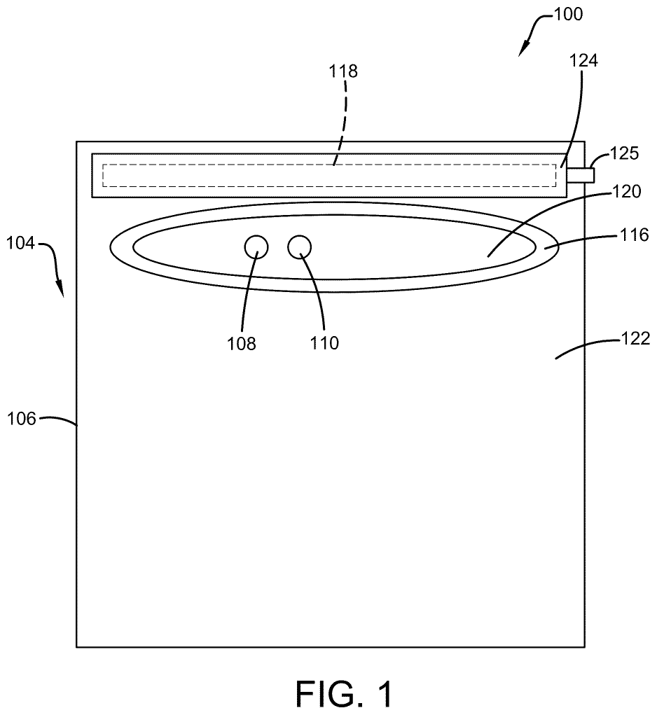

Referring initially to the drawings, FIG. 1 illustrates a top view of a first potential embodiment of a sealable used incontinence garment bag device 100 of the present invention while unsealed in accordance with the disclosed architecture. The device 100 is comprised of disposable bag assembly configured to enable the hygienic and discreet disposal of used incontinence products. More specifically, the device 100 may function to isolate odors, prevent visual exposure of the contents, and provide a sanitary means of disposal for users in residential, public, or travel environments.

The device 100 is comprised of a bag assembly 102. The assembly is comprised of a bag body 104. The bag body 104 may be made from a flexible, waterproof sheet material such as but not limited to polyethylene, polypropylene, polyvinyl chloride, or biopolymers derived from plant-based starches or cellulose. The bag body 104 may be manufactured in a variety of shapes, such as rectangular, oval, or trapezoidal, to accommodate different product sizes or user preferences. In one embodiment, the edges 106 of the bag body 102 may be sealed edges formed using heat sealing, ultrasonic welding, adhesive bonding, or mechanical crimping to create a fully enclosed and leak-resistant body 104.

The bag body 104 may be impregnated with a fragrance compound 108 that may be microencapsulated or integrated into the body 104 material matrix, as seen in FIG. 1. The fragrance compound 108 may include but is not limited to natural essential oils or synthetic aromatic compounds, such as but not limited to lavender, eucalyptus, lemon, mint, or neutral “fresh” scents. In addition to the compound 108, the bag body 104 may be impregnated or coated with an odor-neutralizing compound 110 (as seen in FIG. 1) configured to chemically or physically trap odor molecules within the body 104 once sealed. Such compounds 110 may include but are not limited to any combination of activated carbon, zeolite minerals, cyclodextrins, or enzymatic formulations. Said compounds 110 may be embedded into the body 104 as a coating, blended into the body 104 substrate, or applied to the body 104 as a printed layer.

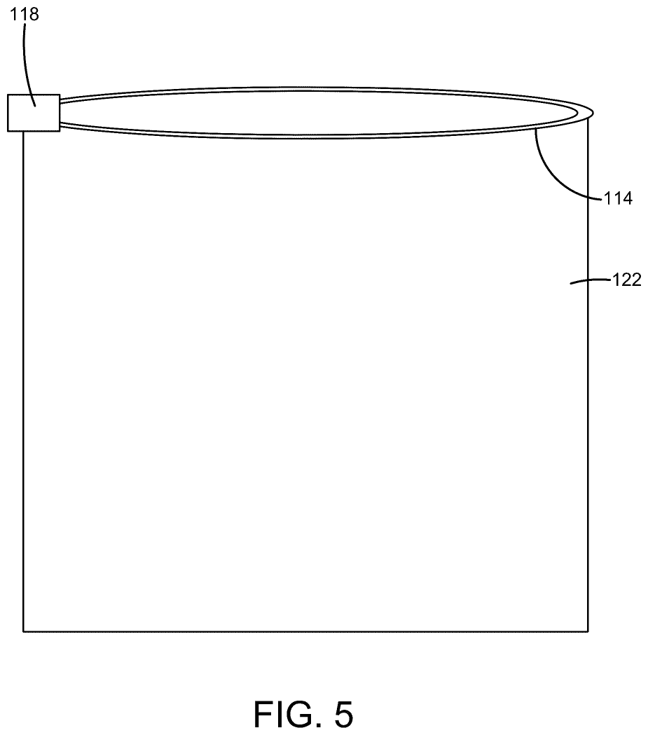

The bag body 104 may be comprised of at least one opening 112 configured to receive used incontinence garments. In a first embodiment, the opening 112 may be positioned along or near a top edge 114 of the bag body 104 (as seen in FIG. 1 and FIG. 5) and may span the full width or a partial segment of the edge 114. In one embodiment, the opening 112 may be maintained in an open position while placing a used incontinence garment into the body 104 via the opening through structural features 116 such as a reinforced rim, flexible band, or gusseted top, as seen in FIG. 1.

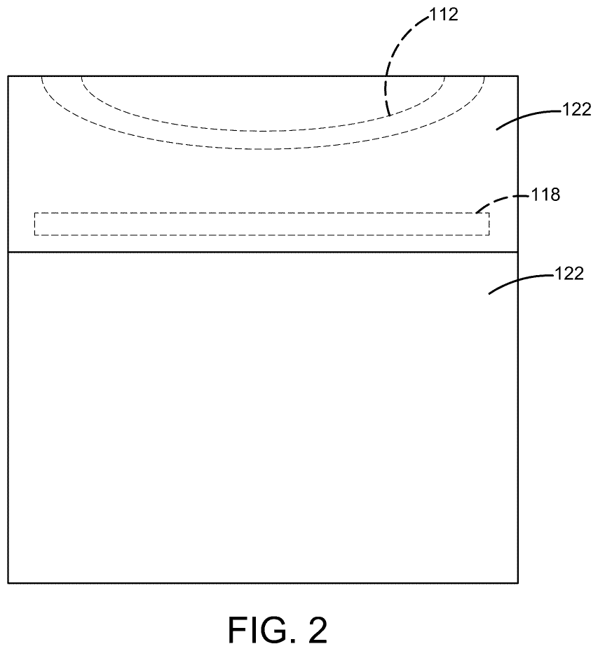

After insertion of the used garment, the opening 112 may be sealed by one or more closure mechanisms 118. In the first embodiment, the opening 112 may be sealed using a mechanism 118 in the form of an adhesive strip affixed to an interior surface 120 and/or exterior surface 122 of the bag body 104, wherein the device 100 is shown in said sealed configuration in FIG. 2. The adhesive may be any type such as but not limited to pressure-sensitive, heat-activated, or solvent-activated, and may be covered by a peelable covering 124 when not in use, as seen in FIG. 1. In one embodiment, the covering 124 is comprised of a pull tab 125 to aid in removing the covering 124 from the mechanism 118. The pull tab 125 may be any size and shape. In a different embodiment, the opening 112 may be in the form of a slidable fastener system, such as but not limited to a zipper-lock closure, interlocking ribs, or a sliding clip track, as seen in FIG. 5

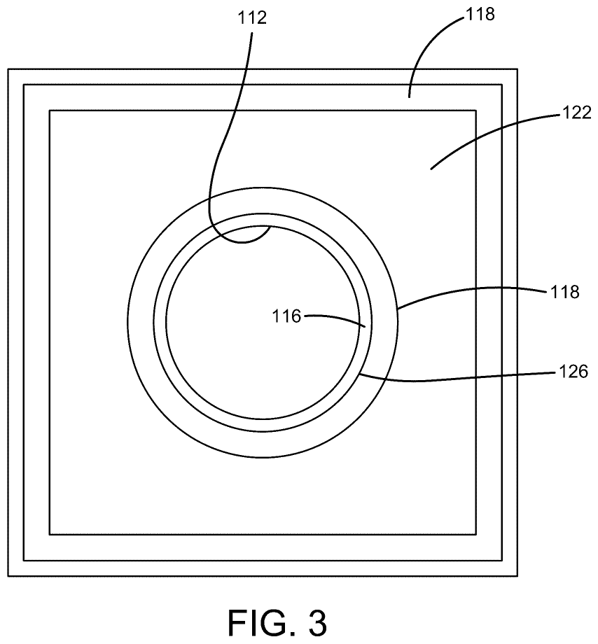

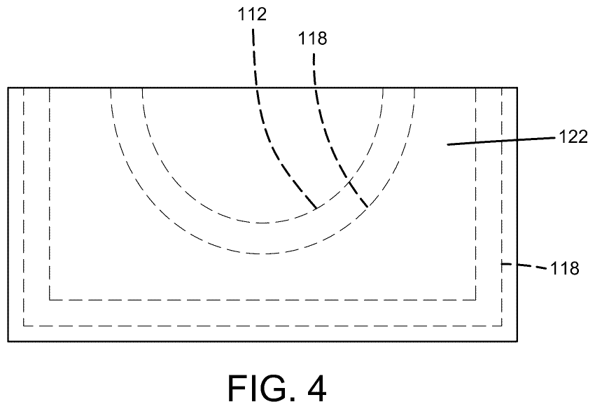

In a second embodiment, the opening 112 may be centrally positioned on the body 104, as seen in FIG. 3. In this embodiment, the opening 112 may be oval, circular, slit-shaped, or custom-shaped. In this embodiment, the perimeter edges 126 of the opening 112 and/or the exterior surface 122 of the body 104 near the edges 106 may be comprised of a mechanism 118 in the form of an adhesive strip, as seen in FIG. 3. The adhesive may be any type such as but not limited to pressure-sensitive, heat-activated, or solvent-activated, and may be covered by a peelable covering 124 when not in use. In this configuration, once a used incontinence garment is inserted into the body 104 via the opening 112, the user may fold the body 104 along a central horizontal or vertical fold axis such that the adhesive 118 make contact with one another and/or other areas of the body 104 and seal the opening 112 closed via securing the body 104 in a folded configuration, as seen in FIG. 4.

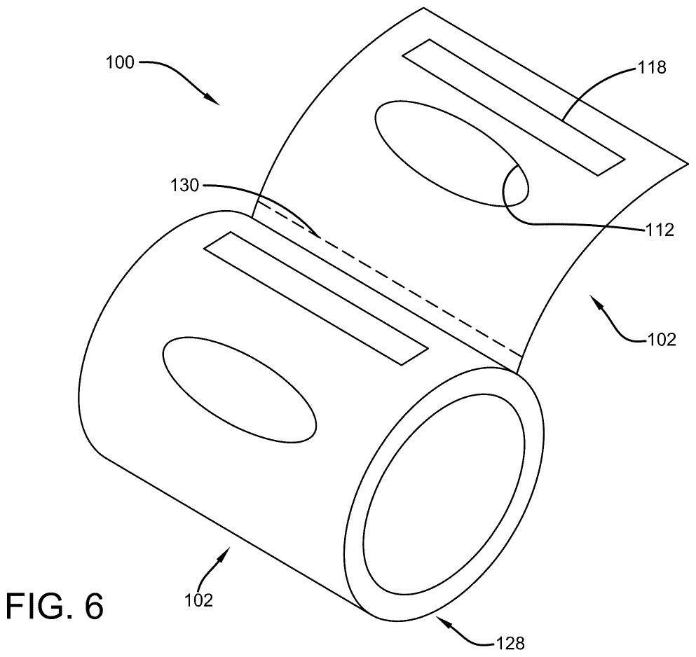

In different embodiments, the bag assembly 102 may be provided as a single-use unit or as part of a continuous roll 128, as seen in FIG. 6. When in roll form 128, multiple bag assemblies 102 may be connected end-to-end and separated by perforation lines 130 designed to tear cleanly when pulled such that a single bag assembly 102 can be separated from the remainder of the roll 128.

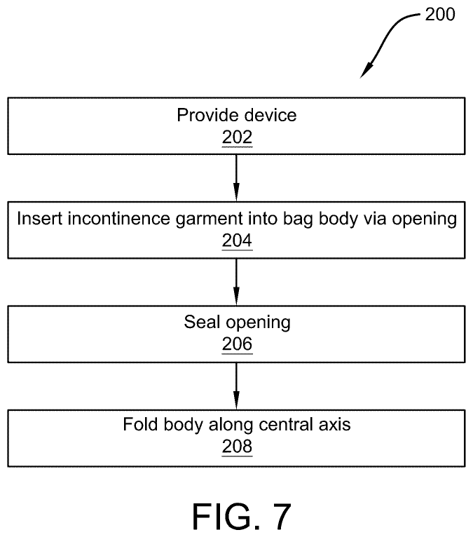

The present invention is also comprised of a method of using 200 the device 100, as seen in FIG. 7. First, a device 100 is provided comprised of a bag assembly 102 comprised of a bag body 104 having at least one opening 112 and at least one closure mechanism 118 [Step 202]. Then, a used incontinence garment is inserted into the bag body 104 via the opening 112, which may be located at a top edge 114 or centrally positioned on the body 104 depending on the embodiment [Step 204]. Next, the opening 112 is sealed using the closure mechanism 118, which may be an adhesive strip positioned on the interior surface 120 or exterior surface 122 of the bag body 104, or alternatively, a slidable fastener system [Step 206]. If the closure mechanism 118 is in the form of an adhesive strip and the opening 112 is centrally positioned, the bag body 104 may be first folded along a central axis to ensure sealing contact between opposing adhesive 118 and the body 104 and/or other adhesive 118, thereby enclosing the opening 112 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “sealable used incontinence garment bag device” and “device” are interchangeable and refer to the sealable used incontinence garment bag device 100 of the present invention.

Notwithstanding the foregoing, the sealable used incontinence garment bag device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the sealable used incontinence garment bag device 100 as shown in the FIGS. are for illustrative purposes only, and that many other sizes and shapes of the sealable used incontinence garment bag device 100 are well within the scope of the present disclosure. Although the dimensions of the sealable used incontinence garment bag device 100 are important design parameters for user convenience, the sealable used incontinence garment bag device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sealable used incontinence garment bag device comprising:
a bag body comprised of a waterproof material, wherein the waterproof material is impregnated with a scent and is comprised of an odor-neutralizing compound;
an opening positioned along a top edge of the bag body; and
a closure mechanism configured to seal the opening.

2. The sealable used incontinence garment bag device of claim 1, wherein the opening is comprised of a reinforced rim, a flexible band, or a gusseted top.

3. The sealable used incontinence garment bag device of claim 1, wherein the closure mechanism is comprised of an adhesive strip.

4. The sealable used incontinence garment bag device of claim 3, wherein the adhesive strip is positioned on an exterior surface of the bag body.

5. The sealable used incontinence garment bag device of claim 3, wherein the adhesive strip is positioned on an interior surface of the bag body.

6. The sealable used incontinence garment bag device of claim 3, wherein the adhesive strip is comprised of a peelable covering further comprised of a pull tab.

7. The sealable used incontinence garment bag device of claim 1, wherein the closure mechanism is comprised of a slidable fastener system.

8. The sealable used incontinence garment bag device of claim 1, wherein the odor-neutralizing compound is comprised of an activated carbon, a zeolite mineral, a cyclodextrin, or an enzymatic formulation.

9. The sealable used incontinence garment bag device of claim 1, wherein the bag body is comprised of a heat-sealed edge, an ultrasonically-welded edge, an adhesively bonded edge, or a mechanical crimped edge.

10. The sealable used incontinence garment bag device of claim 1, wherein the scent is comprised of an essential oil.

11. The sealable used incontinence garment bag device of claim 1, wherein the odor-neutralizing compound is applied to the bag body as a printed layer.

12. A sealable used incontinence garment bag device comprising:
a bag body comprised of a waterproof material, wherein the waterproof material is impregnated with a scent and is comprised of an odor-neutralizing compound;
an opening positioned in a center of the bag body; and
a closure mechanism configured to seal the opening.

13. The sealable used incontinence garment bag device of claim 12, wherein the closure mechanism is comprised of an adhesive strip.

14. The sealable used incontinence garment bag device of claim 13, wherein the adhesive strip is comprised of a peelable covering further comprised of a pull tab.

15. The sealable used incontinence garment bag device of claim 13, wherein the closure mechanism is positioned around an edge of the opening on an exterior surface of the bag body.

16. The sealable used incontinence garment bag device of claim 13, wherein the closure mechanism is positioned around an edge of the bag body on an exterior surface of the bag body.

17. The sealable used incontinence garment bag device of claim 12, wherein the odor-neutralizing compound is comprised of an activated carbon, a zeolite mineral, a cyclodextrin, or an enzymatic formulation.

18. The sealable used incontinence garment bag device of claim 12, wherein the bag body is comprised of a heat-sealed edge, an ultrasonically-welded edge, an adhesively bonded edge, or a mechanical crimped edge.

19. The sealable used incontinence garment bag device of claim 12, wherein the opening is comprised of a reinforced rim, a flexible band, or a gusseted top.

20. A method of using a sealable used incontinence garment bag device, the method comprising the following steps:
providing a sealable used incontinence garment bag device comprised of a bag assembly comprising a bag body comprised of a scent, an odor-neutralizing compound, an opening, and a closure mechanism;
inserting a used incontinence garment into the bag body via the opening; and
sealing the opening using the closure mechanism.
